(19) United States
(12) Patent Application Publication
(10) Pub. No.: US 2022/0154833 A1
(43) Pub. Date: May 19, 2022

(54) MULTI-PORT ROTARY SLIDE VALVE

(71) Applicant: SWR Europe - van Dinther Antriebstechnik GmbH, Gelsenkirchen (DE)

(72) Inventors: Christoph CARLE, Bochum (DE); Frank VAN DINTHER, Bochum (DE)

(73) Assignee: SWR Europe - van Dinther Antriebstechnik GmbH, Gelsenkirchen (DE)

(21) Appl. No.: 17/441,020

(22) PCT Filed: Mar. 20, 2020
(86) PCT No.: PCT/EP2020/057806

§ 371 Date: Sep. 20, 2021

(30) Foreign Application Priority Data
Mar. 21, 2019 (DE) 10 2019 107 296.4

(51) Int. Cl. F16K 11/074; F16K 31/04; F16K 31/53; F16K 37/00

(52) U.S. Cl. CPC F16K 11/074; F16K 31/043; F16K 37/0083; F16K 37/0041; F16K 31/535

(57) ABSTRACT

The invention relates to a multi-port rotary slide valve in which compensation sealing sleeves are arranged in the connection ducts (P, T, A, B), which face the rotatable valve body (2), for a pressure medium source (P), a pressure medium reservoir (T) and pressure medium consumers (A, B), said compensation sealing sleeves having opposing sealing faces which are pressed against the sealing face (3) of the valve body (2) by spring force and by the pressure-medium pressure of the pressure medium passing therethrough. To permit automatic activation in a multi-port rotary slide valve of this kind that functions largely without oil leaks but is relatively stiff, the invention proposes that the activation mechanism of the valve is provided with an electric-motor-operated drive mechanism (11) which has an absolute rotary encoder (17) that monitors each rotational position of the valve body (2) and on the basis of whose measurement data the electric-motor-operated drive mechanism (11) can be controlled by means of a microprocessor.

The invention relates to a multi-port rotary slide valve comprising a valve body that is rotatable about an axis of rotation in a valve housing and has a drive shaft, which is guided out of the valve housing and provided with a drive mechanism, one or more connecting ducts being provided in the valve body, each of which each interconnects two mouths arranged in a sealing face of the valve body, said sealing face extending perpendicularly to the axis of rotation, and connection ducts for a pressure medium source (P), a pressure medium reservoir (T) and pressure medium consumers (A, B) being arranged in the wall of the valve housing that is opposite the sealing face of the valve body, the mouths of said connection ducts corresponding to the mouths of the connecting duct/ducts in the valve body and each being provided with compensation sealing sleeves having opposing sealing faces which can be pressed against the sealing face of the valve body by spring force and by pressure-medium pressure of the pressure medium passing therethrough.

In principle, multi-port rotary slide valves of this kind have been part of the state of the art for decades (see e.g. DE-AS 1 775 343) and are generally also suitable for high-pressure hydraulic systems because they function practically without oil leaks, even at very high pressures, due to the compensation sealing sleeves used for the sealing, just like seat valves. However, multi-port rotary slide valves of said type also have the disadvantage whereby they are relatively stiff, i.e. a relatively high torque has to be applied to the valve body in order to initiate and carry out the rotation of the valve body. This is particularly the case at high pressure-medium pressures, and in each case at the start of any rotation operation, because in those cases the relatively high static friction between the sealing face of the valve body and the sealing faces of the compensation sealing sleeves always has to be overcome first. The unavoidable differences in the frictional resistance also make it difficult to precisely actuate certain switching positions by means of a motorized drive rotationally driving the valve body.

Due to this stiffness and the associated difficulties, multi-port rotary slide valves of this kind have not become established in high-pressure hydraulic systems. Accordingly, these rotary slide valves are practically only used as hand-activated valves in which the valve body is rotated by means of a hand lever. However, multi-port rotary slide valves of this kind activated by means of a hand lever cannot be used for all switching operations, which need to be initiated, carried out and monitored in a largely automated manner.

For the above reasons, to ensure oil leak-free operation that is highly automatable, valve controls that function substantially using seat valves have become established around the world in the field of high-pressure hydraulics, i.e. using valves containing shut-off members that are pressed into a valve seat in the flow direction of the pressure medium under the action of the pressure medium. In most cases, these seat valves are in the form of solenoid valves, which are particularly simple to actuate electrically. However, since a solenoid valve of this kind generally only has two switching positions, i.e. the throughflow position and the shut-off position, multi-port control requires a plurality of said seat valves, which are actuated in a manner adapted to one another.

For example, to activate a dual-action high-pressure hydraulic cylinder, a valve control having the functions of a 4/3-way valve is required. When establishing a valve control of this kind using only seat valves, it is necessary to have two 3/2-way seat valves having electromagnetic actuation, and additionally one 2/2-way seat valve having electromagnetic actuation, which can be arranged in a common housing to save on space. However, this does not change the fact that a valve control of this kind requires a relatively high number of individual parts that are movable with respect to one another, as well as complex electrical actuation for the three electromagnets contained in the valve control, and this results in numerous possibilities for errors as well as significant amounts of work for production and maintenance. This applies similarly to all multi-port valve controls that function using combinations of electromagnetically activated seat valves. All multi-port valve controls of this kind have a large number of sealing edges, O-ring seals and linkages for the actuation. Altogether, therefore, they form a relatively complicated mechanism having a large number of possible sources of error.

The object of the invention is to develop the multi-port rotary slide valve of the type mentioned at the outset so that it is better suited for use in largely automated workflows while basically not changing the design or the hydraulic functionality.

To achieve this object starting from a multi-port rotary slide valve of the type mentioned at the outset, the invention proposes that the drive mechanism is configured to be electric-motor-operated and has an absolute rotary encoder which monitors each rotational position of the valve body and on the basis of whose measurement data the electric-motor-operated drive mechanism can be controlled by means of a microprocessor.

Compared with multi-port valve arrangements that function without oil leaks, the multi-port rotary slide valve according to the invention, which functions without oil leaks, firstly has the advantage of having a particularly simple design with just a few moving parts. A further advantage is that multi-port valves having different functionalities can be produced in a simple manner, without significantly changing the overall design of the valve, by using rotatable valve bodies that have an identical external shape and differ from one another only on account of the arrangement of the connecting ducts in the interior of the valve body. This improves the possibilities for large-batch production of multi-port rotary slide valves having different functionalities. The problems set out at the outset resulting from the stiffness of multi-port rotary slide valves functioning without oil leaks are solved by the invention by an electric-motor-operated drive mechanism and an absolute rotary encoder which monitors each rotational position of the valve body and on the basis of whose measurement data the electrical drive mechanism can be controlled by means of a microprocessor.

The absolute rotary encoder used according to the invention identifies any misalignment of the rotary member caused by different friction conditions, and immediately takes suitable corrective measures by means of the accordingly programmed microprocessor and the electric-motor-operated drive controlled thereby. Consequently, the electric-motor-operated drive, actuated and monitored in this way, of the valve body functions so precisely that the rotation of the valve body in each movement phase can be precisely controlled, and specifically so precisely that the multi-port rotary slide valve according to the invention can additionally take on the function of a proportional valve. Lastly, it is also advantageous that, as a result of the absolute rotary encoder being used, full functionality is retained at all times, i.e. even after a power outage, without having to move to a reference angle in order to restore said functionality.

In a preferred embodiment of the multi-port rotary slide valve according to the invention, the sealing face of the valve body and/or the opposing sealing faces of the compensation sealing sleeves are provided with an anti-friction coating. These anti-friction coatings, which can consist of a metal or a suitable polymer, firmly adhere to the sealing face of the valve body and/or to the opposing sealing faces of the compensation sealing sleeves and ensure extremely low frictional resistances (static friction and kinetic friction) during rotation of the valve body.

Furthermore, the electric-motor-operated drive mechanism is provided with a gearing that increases the torque. This gearing is configured such that, by means of the electric-motor-operated rotary drive, the highest expected torque is achieved at the start of and during the rotation of the valve body to a sufficient degree of certainty.

Preferably, a worm gear, which, as is known, can generate particularly high torques, is used as the gearing for increasing the torque. Alternatively, however, an epicyclic gearing can also be used for this purpose.

Lastly, a device for providing a brief voltage overshoot is assigned to the electric-motor-operated drive mechanism. This voltage overshoot is expediently used when it is determined, by means of the absolute rotary encoder, that the valve body cannot be set in motion due to excessive static friction. In this situation, owing to the voltage overshoot triggered by means of the microcontroller, a high breakaway torque can be generated, which sets the valve body in motion by overcoming the static friction.

An embodiment example of the invention will be explained in more detail below on the basis of the accompanying drawings, in which:

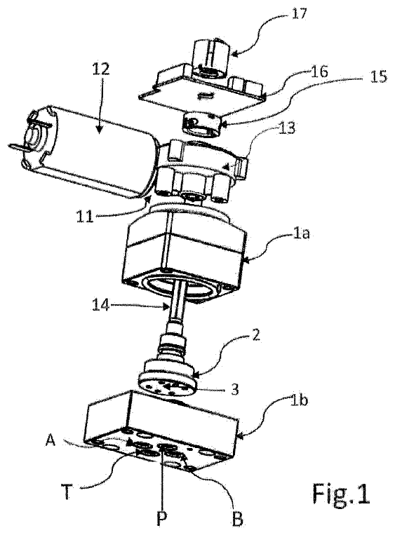

FIG. 1 is an exploded view of the essential parts of a multi-port rotary slide valve according to the invention obliquely from below;

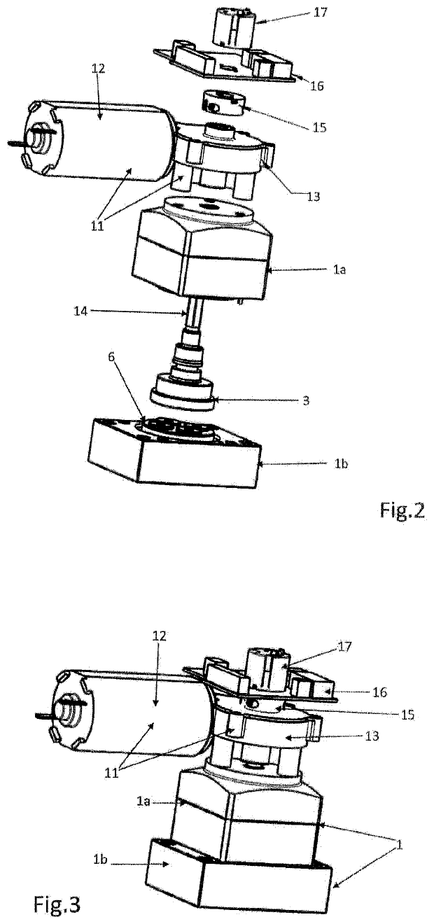

FIG. 2 is an exploded view of the essential parts of a multi-port rotary slide valve according to the invention obliquely from above;

FIG. 3 shows the multi-port rotary slide valve shown in FIGS. 1 and 2 in the fully assembled state;

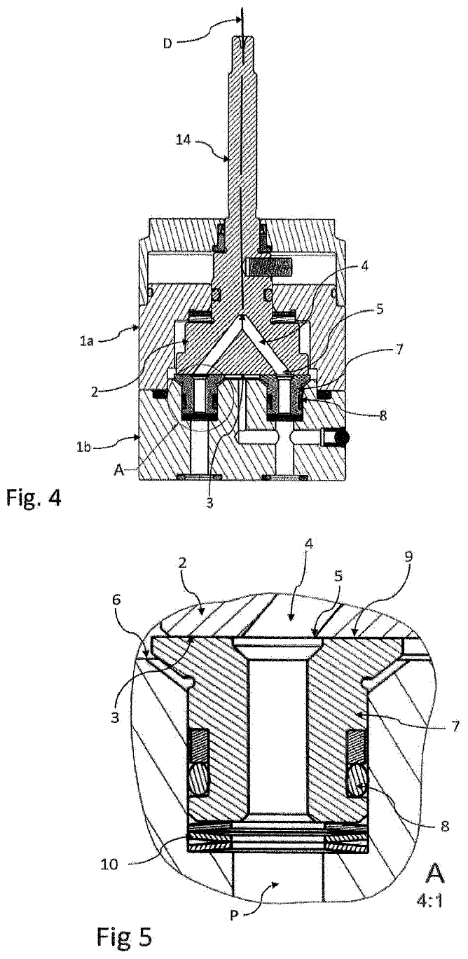

FIG. 4 is a sectional view of a multi-port rotary slide valve without the drive mechanism;

FIG. 5 is a longitudinal section through a compensation sealing sleeve arranged in a mouth of a pressure medium duct (detail A from FIG. 4);

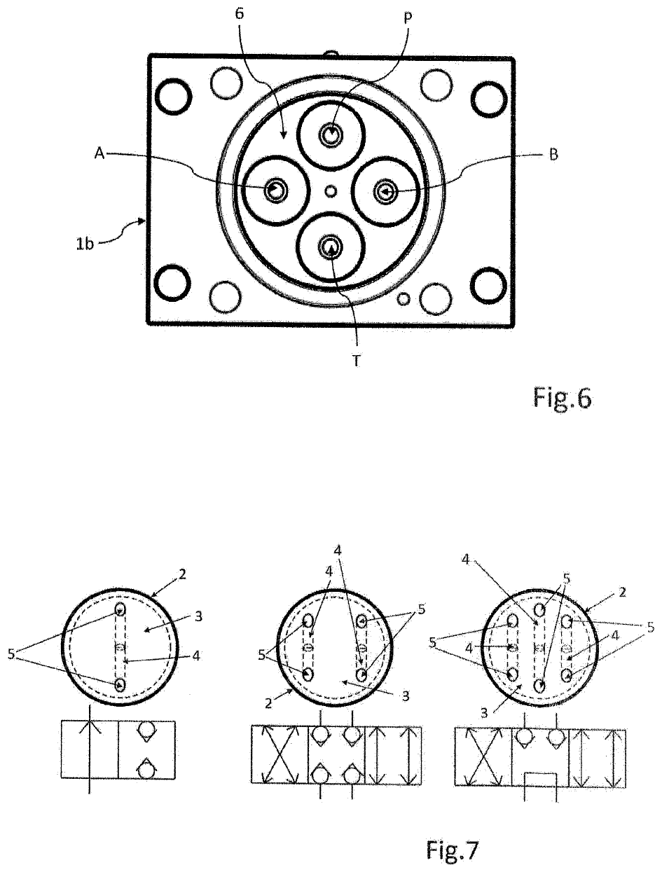

FIG. 6 is a plan view of the bottom housing part of the multi-port rotary slide valve shown in FIG. 1;

FIG. 7 shows the sealing faces of three different valve bodies having connecting ducts that run differently in the valve body, together with the associated representational schematic diagrams for the valve functions that can be achieved using each valve body.

In the drawings, the valve housing of a multi-port rotary slide valve according to the invention is denoted in its entirety by reference numeral 1. This valve housing 1 consists of a top housing part 1a and a bottom housing part 1b. In the interior of the housing 1, a valve body 2 is arranged so as to be rotatable about an axis of rotation D and has a planar sealing face 3 extending perpendicularly to the axis of rotation D.

In the interior of the valve body 2, one or more connecting ducts 4 are provided, each of which interconnects two mouths 5 arranged in pairs in the sealing face 3 of the valve body 2. In addition, four mouths, which are fixed to the housing, of four pressure medium ducts P, T, A and B, which are fixed to the housing, are arranged in a wall 6 of the bottom housing part 1b that is opposite the sealing face 3 of the valve body 2, along a circular line around the axis of rotation D of the valve body 2.

Compensation sealing sleeves 7 are inserted into the respective mouths, which are fixed to the housing, of the pressure medium ducts P, T, A and B and are sealed by means of O-rings 8 in said mouths and abut the sealing face 3 of the rotatable valve body 2 by means of larger opposing sealing faces 9. As a result of the force of disc springs 10 and the pressure prevailing in the respective pressure medium ducts, said compensation sealing sleeves 7 are pressed towards the sealing face 3 of the rotatable valve body 2, where they provide sealing that is largely oil leak-free, without generating excessively large axial forces.

The mouths 5 of the connecting ducts 4 in the valve body 2 on the one hand, and the mouths of the pressure medium ducts P, T, A and B in the bottom housing part 1b on the other hand, are all arranged so as to correspond along a circular line around the axis of rotation D of the valve body 2, specifically such that the pressure medium ducts P, T, A and B can be connected to each other or separated from each other by rotating the valve body 2 depending on the desired valve function.

To rotate the valve body 2 into the different switching positions, an electric-motor-operated drive mechanism 11 is attached to the exterior of the valve housing 1 and has an electric motor 12 and a reduction gear 13 (worm gear or epicyclic gearing), the output shaft of which is connected to a drive shaft 14 of the valve body 2 that is guided out of the valve housing 1.

This electric-motor-operated drive mechanism 11 is connected to a control unit 16 by means of a bracket 15, said control unit including a voltage converter, a programmable microprocessor and switch elements controlled by said microprocessor for controlling the electric motor 12. According to the invention, this control unit 16 is connected to an absolute rotary encoder 17, which precisely establishes each rotational position of the valve body 2 and forwards it to the microprocessor of the control unit 16, the microprocessor monitoring, in a manner controlled by its installed program, the proper functioning of the multi-port rotary slide valve and being able to initiate the next step for the switchover and any necessary corrective measures in each rotational position of the valve body.

Lastly, FIG. 7 shows how, by merely arranging connecting ducts 4 differently in the valve body 2 while the rest of the design otherwise remains entirely the same, it is possible to produce multi-port rotary slide valves having different functions, namely, by way of example, a 2/2-way valve (shown on the left), a 4/3-way valve having a shut-off center position (shown in the middle) or a 4/3-way valve having a shut-off center position and neutral circulation between the pump and the reservoir (shown on the right).

1. A multi-port rotary slide valve, having a valve body (2) which is rotatable about an axis of rotation (D) in a valve housing (1) and which comprises a drive shaft (14) that is guided out of the valve housing (1) and that is provided with a drive mechanism (11),
wherein one or more connecting ducts (4) are provided in the valve body (2), each of which interconnects two mouths (5) arranged in a sealing face of the valve body which sealing face extends perpendicularly to the axis of rotation (D),
and wherein connection ducts (P, T, A, B) for a pressure medium source (P), a pressure medium reservoir (T) and pressure medium consumers (A, B) are arranged in the wall (6) of the valve housing (1) that is opposite the sealing face (3) of the valve body (2), the mouths of which correspond to the mouths (5) of the connecting duct/ducts (4) in the valve body (1) and each are provided with compensation sealing sleeves (7) having opposing sealing faces (9) which can be pressed against the sealing face (3) of the valve body (2) by spring force and by pressure-medium pressure of the pressure medium passing therethrough,
wherein
the drive mechanism (11) is configured to be electric-motor-operated and comprises an absolute rotary encoder (17) which monitors each rotational position of the valve body (2), on the basis of whose measurement data the electric-motor-operated drive mechanism (11) can be controlled by means of a microprocessor.

2. The multi-port rotary slide valve according to claim 1, wherein the sealing face (3) of the valve body (2) and/or the opposing sealing faces (9) of the compensation sealing sleeves (7) are provided with an anti-friction coating.

3. The multi-port rotary slide valve according to claim 1, wherein the electric-motor-operated drive mechanism (11) is provided with a gearing (13) that increases the torque.

4. The multi-port rotary slide valve according to claim 3, wherein the gearing (13) is in the form of a worm gear.

5. The multi-port slide valve according to claim 3, wherein the gearing (13) is in the form of an epicyclic gearing.

6. The multi-port rotary slide valve according to claim 3, wherein a device for providing a brief voltage overshoot is assigned to the electric-motor-operated drive mechanism (11).

7. The multi-port rotary slide valve according to claim 2, wherein the electric-motor-operated drive mechanism (11) is provided with a gearing (13) that increases the torque.

8. The multi-port rotary slide valve according to claim 7, wherein the gearing (13) is in the form of a worm gear.

9. The multi-port slide valve according to claim 7, wherein the gearing (13) is in the form of an epicyclic gearing.

10. The multi-port rotary slide valve according to claim 7, wherein a device for providing a brief voltage overshoot is assigned to the electric-motor-operated drive mechanism (11).
